(19) United States
(12) Patent Application Publication
(10) Pub. No.: US 2025/0091264 A1
(43) Pub. Date: Mar. 20, 2025

(54) RESIN COMPOSITION FOR INJECTION MOLDING, INJECTION MOLDED ARTICLE, METHOD FOR MANUFACTURING INJECTION MOLDED ARTICLE, AND METHOD FOR ANALYZING INJECTION MOLDED ARTICLE

(71) Applicant: FURUKAWA ELECTRIC CO., LTD., Tokyo (JP)

(72) Inventors: Takahiro MIURA, Tokyo (JP); Takanori YAMAZAKI, Tokyo (JP); Masahiro HANDA, Tokyo (JP); Masayoshi TSUKAMOTO, Tokyo (JP)

(73) Assignee: FURUKAWA ELECTRIC CO., LTD., Tokyo (JP)

(21) Appl. No.: 18/962,558

(22) Filed: Nov. 27, 2024

Related U.S. Application Data
(63) Continuation of application No. PCT/JP2023/018994, filed on May 22, 2023.

(30) Foreign Application Priority Data
Jun. 2, 2022 (JP) 2022-090031

(51) Int. Cl. B29C 45/00; B29K 81/00; B29K 105/18; B29K 509/08; G02B 6/38

(52) U.S. Cl. CPC B29C 45/0013; B29C 45/0001; G02B 6/3854; B29K 2081/04; B29K 2105/18; B29K 2509/08

(57) ABSTRACT

The present invention intends to estimate the orientation of a resin while suppressing anisotropy. The resin composition for injection molding according to the present invention including a first thermoplastic resin and a filler including a non-fibrous first inorganic particle, further including at least one of an aggregate of second inorganic particles and a resin composition of a second thermoplastic resin. A ratio of a longest first length to a shortest second length among lengths of the aggregate and the resin composition in three directions orthogonal to each other is larger than or equal to 2 and smaller than or equal to 20, and the first length is larger than or equal to 25 μm and smaller than or equal to 100 μm. The aggregate or the resin composition does not include the first inorganic particles having a particle diameter of larger than or equal to 25 μm.

### CROSS-REFERENCE TO RELATED APPLICATIONS

This application is a continuation application of International Application No. PCT/JP2023/018994, filed May 22, 2023, which claims the benefit of Japanese Patent Application No. 2022-090031, filed Jun. 2, 2022, both of which are hereby incorporated by reference herein in their entirety.

### BACKGROUND OF THE INVENTION

### Field of the Invention

The present invention relates to a resin composition for injection molding, an injection molded article, a method for manufacturing an injection molded article, and a method for analyzing an injection molded article.

### Description of the Related Art

A technique of analyzing a thermal expansion/contraction direction of an injection molded article by using a filler in the injection molded article as a tracer is known. In the technique described in Japanese Patent Application Laid-Open No. 2014-100879, a flow direction of a resin is estimated from a fiber direction of a fibrous inorganic particle in the injection molded article, and a hot warp of the injection molding is analyzed.

### SUMMARY OF THE INVENTION

Since the fibrous inorganic particles cannot be deformed in accordance with the expansion and contraction of the surrounding resin, the deformation of the resin is restricted, and the anisotropy of the injection molded article is enhanced.

The present invention has been made in view of the above and intends to make it possible to estimate the orientation of a resin while suppressing anisotropy.

According to one aspect of the present invention, provided is a resin composition for injection molding including a first thermoplastic resin and a filler including a non-fibrous first inorganic particle, further comprising at least one of an aggregate of second inorganic particles and a resin composition of a second thermoplastic resin. A ratio of a longest first length to a shortest second length among lengths of the aggregate and the resin composition in three directions orthogonal to each other is larger than or equal to 2 and smaller than or equal to 20, and the first length is larger than or equal to 25 μm and smaller than or equal to 100 μm. The aggregate or the resin composition does not include the first inorganic particles having a particle diameter of larger than or equal to 25 μm.

According to another aspect of the present invention, provided is a method for manufacturing an injection molded article including a step first of kneading a first thermoplastic resin, a non-fibrous first inorganic particle, and at least one of an aggregate of second inorganic particles and a resin composition of a second thermoplastic resin and a second step of injection-molding a mixture of the first step. A ratio of a longest first length to a shortest second length among lengths of the aggregate and the resin composition in three directions orthogonal to each other is larger than or equal to 2 and smaller than or equal to 20, and the first length is larger than or equal to 25 μm and smaller than or equal to 100 μm. The aggregate or the resin composition does not include the first inorganic particles having a particle diameter of larger than or equal to 25 μm.

According to another aspect of the present invention, provided is a method for analyzing an injection molded article including acquiring a tomographic image of an injection molded article including a first thermoplastic resin, a non-fibrous first inorganic particle, and at least one of an aggregate of second inorganic particles and a resin composition of a second thermoplastic resin and determining an orientation of the aggregate or the resin composition in the tomographic image. A ratio of a longest first length to a shortest second length among lengths of the aggregate and the resin composition in three directions orthogonal to each other is larger than or equal to 2 and smaller than or equal to 20, and the first length is larger than or equal to 25 μm and smaller than or equal to 100 μm. The aggregate or the resin composition does not include the first inorganic particles having a particle diameter of larger than or equal to 25 μm.

According to the present invention, it is possible to estimate the orientation of a resin while suppressing anisotropy.

### BRIEF DESCRIPTION OF THE DRAWINGS

FIG. 1 is an external view of a ferrule according to one embodiment of the present invention.

FIG. 2 is a flowchart illustrating a method for manufacturing a ferrule according to one embodiment of the present invention.

FIG. 3 is a cross-sectional view of a ferrule according to one embodiment of the present invention.

FIG. 4A is a cross-sectional view of a ferrule according to one embodiment of the present invention.

FIG. 4B is a cross-sectional view of a ferrule according to one embodiment of the present invention.

FIG. 4C is a cross-sectional view of a ferrule according to one embodiment of the present invention.

FIG. 4D is a cross-sectional view of a ferrule according to one embodiment of the present invention.

FIG. 4E is a cross-sectional view of a ferrule according to one embodiment of the present invention.

FIG. 4F is a cross-sectional view of a ferrule according to one embodiment of the present invention.

FIG. 5 is a schematic diagram of an analyzing apparatus of a resin orientation according to one embodiment of the present invention.

FIG. 6 is a flowchart of a method for analyzing a resin orientation according to one embodiment of the present invention.

### DESCRIPTION OF THE EMBODIMENTS

A resin composition for injection molding and an injection molded article according to one embodiment of the present invention will be described by taking a ferrule used for a connector of an optical fiber as an example.

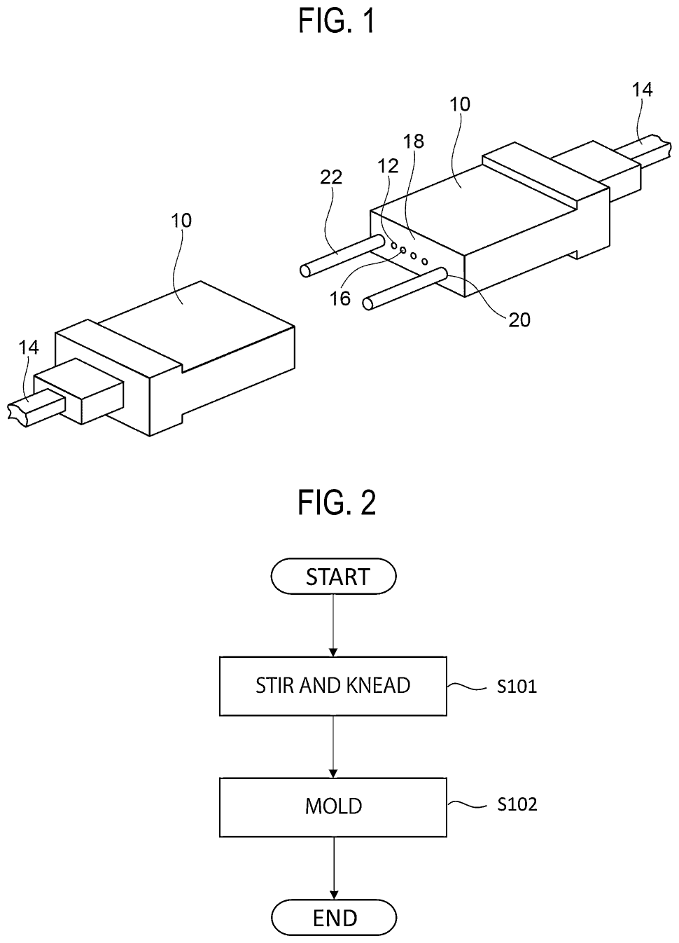

FIG. 1 is an external view of a ferrule according to the present embodiment. The ferrule (component for an optical electronic device) is used as an optical connector for optically connecting optical fibers. FIG. 1 illustrates a ferrule of an MT (Mechanically Transferable) connector, but the ferrule in the present embodiment may be an MPO (Multifiber Push-On) connector or the like.

As illustrated in FIG. 1, the ferrule 10 has a substantially rectangular parallelepiped shape, and a plurality of optical fiber insertion holes 12 are formed in an end surface 18 of the ferrule 10. A coated optical fiber 14 includes a plurality of optical fibers 16, and the optical fibers 16 are inserted into the optical fiber insertion holes 12, respectively, and fixed with an adhesive or the like. The end surface 18 is polished by, for example, PC (Physical Contact) polishing, SPC (Super PC) polishing, UPC (Ultra PC) polishing, APC (Angled PC) polishing, or the like.

The ferrule 10 does not necessarily have to be provided with a plurality of optical fiber insertion holes 12. In the case where the optical fiber 14 is a single fiber including only a single optical fiber 16, a single optical fiber insertion hole 12 is formed in the ferrule 10.

The ferrule 10 is further formed with a pair of guide pin insertion holes 20. The pair of guide pin insertion holes 20 are formed in the ferrule 10 so as to be located on both sides of the plurality of optical fiber insertion holes 12. The pair of guide pin insertion holes 20 are formed in the ferrule 10 along the connecting direction of the optical fiber 16. A guide pin 22 for alignment is inserted into each of the pair of guide pin insertion holes 20.

The guide pins 22 are inserted into the respective guide pin insertion holes 20 of the pair of ferrules 10, and the two ferrules 10 are aligned. The two end surfaces of the optical fibers 16 are in contact with each other, and the two ferrules 10 are fixed by a fixing jig such as a clip. As a result, the optical fibers 16 are connected. A configuration of aligning and fixing the two ferrules 10 is not limited thereto. The two ferrules 10 may be aligned and fixed through, for example, an adapter.

Next, the resin composition for injection molding used in the ferrule will be described. The resin composition for injection molding is injected into a mold to manufacture a ferrule 10 as an injection molded article. The resin composition for injection molding in the present embodiment includes a first thermoplastic resin and a first inorganic particle (non-fibrous inorganic particle) as a filler. The resin composition for injection molding further includes, as a tracer, at least one of an aggregate of second inorganic particles and a resin composition of a second thermoplastic resin. Hereinafter, components of the resin composition for injection molding will be described in detail.

### [First Thermoplastic Resin]

The first thermoplastic resin is a matrix resin constituting the continuous phase of the ferrule 10. The first thermoplastic resin is a resin excellent in precision moldability, and is suitable as a matrix resin constituting the continuous phase of the ferrule 10 requiring precision molding. The first thermoplastic resin includes, but is not particularly limited to, a polyphenylene sulfide (PPS) resin, a polycarbonate (PC) resin, a polyethersulfone (PES) resin, a liquid crystal polymer (LCP), a modified polyphenylene ether (PPE), a polyether ether ketone (PEEK) resin, or the like, and is preferably a PPS resin from the viewpoint of dimensional stability, strength, moldability, and the like. The structure of the PPS resin may be a cross-linked type or a linear type, and the structure, the molecular weight, and the like thereof may be appropriately selected and used according to the characteristics required for the ferrule 10.

The first thermoplastic resin is not limited to one type of resin, and may be composed of a plurality of types of resins. Further, the first thermoplastic resin may be a mixture of resins of different grades among the same type of resin. For example, the first thermoplastic resin may be a mixture of one type of PPS resin, two grades of PPS resin of cross-linked type and linear type, or a mixture of PPS resin and elastomer resin.

Like the aggregate and the resin composition, the first thermoplastic resin may be colored black by carbon black or the like. Coloring of each component will be described later.

### [Aggregate]

The aggregate is composed of inorganic particles such as silica particles, calcium carbonate, and carbon black, and can be used as a tracer. When inorganic particles of carbon black such as furnace black, acetylene black, and thermal black are used, it is possible to easily control the size of the aggregate. In particular, since furnace black has high stability as an aggregate, it is suitable as inorganic particles constituting the aggregate.

The aggregate preferably has an anisotropic shape such as a rod shape or a flat shape so as to function as a tracer. In the aggregate, the aspect ratio between the longest first length and the shortest second length among the lengths in the three directions orthogonal to each other may have an aspect ratio of preferably larger than or equal to 2 and smaller than or equal to 20. For example, when the aggregate has a flat shape, the first length corresponds to the major axis length of the aggregate in plan view, and the second length corresponds to the thickness orthogonal to the minor axis length and the major axis length of the aggregate. The aggregate is oriented in accordance with the flow direction of the resin in the injection molding step, and the longitudinal direction (first direction) of the aggregate faces the flow direction of the resin. The major surface of the flat aggregate is parallel to the flow direction of the resin. As described above, since the aggregate has a relatively large aspect ratio, the aggregate can function as a tracer that estimates the flow direction of the resin during injection molding.

When the major axis length of the aggregate is too short, the aggregate cannot be clearly observed by a general optical microscope or digital microscope. On the other hand, when the major axis length of the aggregate is too long, the aggregate becomes visible to the naked eye on the surface of the ferrule 10, and the aesthetic appearance of the article may be impaired. In addition, in the manufacturing process of the ferrule 10, the aggregate may be easily divided. For the above reasons, the major axis length of the aggregate is preferably larger than or equal to 25 μm and smaller than or equal to 100 μm.

The aspect ratio and major axis length of the aggregate can be appropriately adjusted to desired values according to conditions such as the particle diameter of the inorganic particle, the presence or absence of a granulation process, the screw rotation speed at the time of injection molding, and the kneading temperature. Further, when carbon black is used as the aggregate, the aspect ratio and major axis length of the aggregate can be adjusted to desired values according to the oil absorption amount of the carbon black.

The particle diameter of the inorganic particle constituting the aggregate is preferably smaller than or equal to 1 μm. Carbon black is an aggregate composed of carbon particles of smaller than or equal to 1 μm and is suitable as inorganic particle constituting the aggregate. When the particle diameter of the inorganic particle exceeds 1 μm, the inorganic particle constituting the aggregate restricts the movement of the surrounding resin, hinders the expansion and contraction of the surrounding resin, and increases the anisotropy.

As the inorganic particle constituting the aggregate, particle having a large van der Waals force acting between the inorganic particles and having a high aggregation property is preferable. For example, the Hamaker constant of the inorganic particle in vacuum may be larger than or equal to 10. Graphite and silica particles are preferable because they have large aggregation property, and carbon black is more preferable because they have particularly large aggregation property. Due to the strong aggregation property of the inorganic particle, the aggregate is less likely to be divided during the process to an invisible size, and the aggregate can function as tracers in molded articles.

An aggregate composed of inorganic particles having a small particle diameter can be slightly deformed by tensile stress or compressive stress from a resin around the aggregate regardless of the shape of the inorganic particles. Therefore, as compared with a single inorganic particle, the aggregate of inorganic particles does not restrict the movement of the surrounding resin, and can reduce thermal deformation and anisotropy in the injection molded article. The plurality of inorganic particles are aggregated by an attractive force between surfaces such as a Coulomb force or a van der Waals force. Here, when a force is applied to the inorganic particles from the surrounding resin, each of the inorganic particles may relatively move over a short distance while maintaining contact with the surface. Therefore, in the injection molding process, the aggregates are oriented according to the flow of the surrounding resin without being separated into individual inorganic particles. The aggregates may maintain a flat, rod-like shape or the like and function as tracers up to the final product. As described above, by using the aggregate of the inorganic particles as the tracer, it is possible to obtain an effect that cannot be realized by a single inorganic particle, in which expansion and contraction of the surrounding resin is not hindered. Although the aggregate may expand or contract as the temperature of the surrounding resin changes, the shape of the aggregate does not change significantly. In addition, in the injection molding process, shear stress is applied to the aggregate, and the aggregate may slightly elongate in the shear stress direction. However, even in this case, the shape of the aggregate does not change significantly, and the function as a tracer is not lost.

### [Resin Composition]

The resin composition is composed mainly of the second thermoplastic resin. The resin composition may have an aspect ratio and size similar to the aggregate described above. That is, the resin composition preferably has an aspect ratio of larger than or equal to 2 and smaller than or equal to 20 and a major axis length of larger than or equal to 25 μm and smaller than or equal to 100 μm. This facilitates identification of the resin composition as a tracer. As one example, the resin composition may be a resin burn that produces when the resin is overheated.

The second thermoplastic resin constituting the resin composition may preferably be polyarylene sulfide such as PPS resin. When heated, polyarylene sulfide crosslinks and prolongs molecules and increases molecular weight. Further, an increase in softening point and insolubilization occur with blackening. Therefore, the polyarylene sulfide blackened by heating does not melt even at the molding temperature while maintaining strength and elasticity, and can function as a tracer. The resin composition has a softening temperature higher than that of polyarylene sulfide. Since the resin composition contains polyarylene sulfide as a main component, it has a specific gravity comparable to that of polyarylene sulfide.

The resin composition may be molded into a desired aspect ratio and size in advance, and then added to a resin composition for injection molding such as the first thermoplastic resin. Alternatively, instead of adding the resin composition composed of the second thermoplastic resin, a resin composition in which a part of the first thermoplastic resin is blackened may be used as the tracer. That is, when the mixture including the first thermoplastic resin is extruded by the heated screw of the twin-screw kneading extruder, a resin burn (resin composition) in which a part of the first thermoplastic resin is blackened is generated. For example, when the screw temperature of the twin-screw kneading extruder is set to 330° C. or higher, the thermoplastic resin is baked on the screw surface. Further, the resin composition may have a desired aspect ratio and size by appropriately adjusting the screw rotation speed.

The resin composition is preferably not melted and divided by heating during the injection molding process. That is, the softening temperature of the resin composition is preferably higher than the softening temperature of the first thermoplastic resin. Accordingly, since the resin composition is not melted and divided in the injection molding process, the resin composition can maintain the function of the tracer. The softening temperature of the resin composition can be measured using a scanning probe microscope (SPM). Specifically, the resin composition is heated in a state where the probe of the SPM is pressed against the resin composition. The softening temperature of the resin composition is measured by reading the displacement of the resin composition at this time. The softening temperature of the crystalline resin is a temperature near the melting point, and the softening temperature of the amorphous resin is near the glass transition point. For example, the first thermoplastic resin may be a PPS resin (melting point of about 290° C.), and the second thermoplastic resin included in the resin composition may be a PEEK resin (melting point of 334° C.).

The type of the second thermoplastic resin constituting the resin composition is not limited as long as the second thermoplastic resin expands and contracts without restricting the surrounding resin, but the second thermoplastic resin preferably has the same characteristics as those of the first thermoplastic resin. In particular, when the second thermoplastic resin is the same type as the first thermoplastic resin, the specific gravity of the resin composition and the specific gravity of the surrounding resin are substantially the same, and the affinity between the resin composition and the surrounding resin is improved. Therefore, separation between the resin composition and the surrounding resin and uneven distribution of the resin composition can be reduced.

Even when the first thermoplastic resin and the second thermoplastic resin are the same type, the resin composition needs to be identified as a tracer. That is, the resin composition observed by a microscope or an X-ray CT apparatus needs to have a color or brightness different from that of the surrounding first thermoplastic resin. For example, when both the first thermoplastic resin and the second thermoplastic resin are PPS, the resin composition is blackened by heat process, and thus can be identified as a tracer. The resin composition may be colored with a pigment such as carbon black. When the first thermoplastic resin is also colored in black by carbon black, the resin composition is preferably colored in black which is darker than black of the first thermoplastic resin. As described above, the resin composition may be identified as a tracer by having a lower brightness than the first thermoplastic resin, that is the surrounding resin.

The content of the tracer in the resin composition or aggregate is not particularly limited, but may be appropriately determined according to various conditions such as the strength and appearance of the molded article and the number of pieces of orientation information. When the content of the tracer in the molded article is small, the influence of the tracer on the strength and appearance of the molded article can be reduced. For example, when the tracer content is a small amount and one tracer is included in 10 molded articles, 100 tracers may be included in 1000 molded articles manufactured under the same conditions. By observing 100 tracers, the orientation of the resin or molecule at 100 positions can be estimated, and sufficient orientation information can be obtained. When 1000 tracers are included in one molded article, detailed orientation information can be obtained by observing a smaller number of molded articles. Also in this case, since the volume per tracer is minute, the influence of mechanical strength or the like on the molded article is small enough not to cause a problem in practical use. Therefore, it is preferable that about 0.1 to 1000 tracers are included in one molded article, and in this case, sufficient orientation information can be obtained while minimizing the influence on the molded article.

### [Non-Fibrous Inorganic Particles]

The non-fibrous inorganic particle (first inorganic particle) is used as a filler and constitute the dispersed phase with respect to the continuous phase of the first thermoplastic resin. The inclusion of the filler in the first thermoplastic resin reduces the molding shrinkage, reduces the coefficient of linear expansion, and improves dimensional accuracy of the ferrule 10. The non-fibrous inorganic particles may be, for example, amorphous silica particles, calcium carbonate, and the like produced by crushing.

The non-fibrous inorganic particles preferably have a shape and a particle diameter that can be distinguished from aggregates and resin compositions that are tracers. Hereinafter, the shape and particle diameter of the non-fibrous inorganic particle will be described in detail.

The non-fibrous inorganic particles preferably do not have a particle diameter of larger than or equal to 25 μm in the aggregate or the resin composition. When the non-fibrous inorganic particles having a large particle diameter are included in the aggregate and the resin composition which are tracers, visibility of the tracers may be reduced. Therefore, when non-fibrous inorganic particles having a particle diameter of larger than or equal to 25 μm are not included in the aggregate or the resin composition, it is possible to prevent a decrease in visibility of the tracer.

The shape of the non-fibrous inorganic particles is preferably a spherical shape or a polygonal shape having symmetry. In particular, when the non-fibrous inorganic particles are spherical, it is possible to reduce wear of the mold. Further, the aspect ratio of the non-fibrous inorganic particles is preferably smaller than the aspect ratio of the aggregate and the resin composition. For example, when the aspect ratio of the aggregate and the resin composition is larger than or equal to 2, the aspect ratio of the non-fibrous inorganic particles is preferably smaller than or equal to 2.

The particle diameter of the non-fibrous inorganic particles is preferably smaller than that of the aggregate and the resin composition. For example, when the major axis length of the aggregate and the resin composition is larger than or equal to 25 μm and smaller than or equal to 100 μm, the cumulative 99% particle diameter D₉₉ of the non-fibrous inorganic particles is preferably smaller than or equal to 25 μm, and more preferably smaller than or equal to 10 μm. Here, the cumulative 99% particle diameter D₉₉ is a particle diameter at which the accumulation of small particle diameters is 99% in the cumulative particle diameter distribution curve based on volume. That is, when almost all of the non-fibrous inorganic particles have a diameter of 25 μm, it is possible to prevent confusion between the non-fibrous inorganic particles and the aggregate and the resin composition which are tracers.

The lower limit of the particle diameter of the non-fibrous inorganic particles is not particularly limited. However, the non-fibrous inorganic particles having a small particle diameter may increase the viscosity of the resin and cause a decrease in the terminal transferability of injection molding. Therefore, the cumulative 10% particle diameter D₁₀ of the non-fibrous inorganic particles is preferably larger than or equal to 0.5 μm. That is, when the cumulative 10% particle diameter D₁₀ of the non-fibrous inorganic particles is larger than or equal to 0.5 μm, good fluidity of the resin can be maintained, and the occurrence of the above-described defects can be prevented.

The addition amount of the non-fibrous inorganic particles in the resin composition for injection molding is preferably larger than or equal to 50% by weight and smaller than or equal to 85% by weight, and more preferably larger than or equal to 65% by weight and smaller than or equal to 80% by weight. In the resin composition for injection molding, the first thermoplastic resin as the continuous phase and the non-fibrous inorganic particles as the dispersed phase form a so-called sea-island structure, and the non-fibrous inorganic particles have a clear contour with the surrounding first thermoplastic resin. Therefore, the non-fibrous inorganic particles are easily identified by an optical microscope, a digital microscope, an X-ray CT, or the like. In addition, the non-fibrous inorganic particles can be easily distinguished from the tracer such as the color tone of the non-fibrous inorganic particles as compared with the first thermoplastic resin in terms of appearance. Therefore, when the addition amount of the non-fibrous inorganic particles is larger than or equal to 50% by weight, the continuous layer of the first thermoplastic resin becomes small, and identification of the tracer is facilitated. Further, when the addition amount of the non-fibrous inorganic particles is larger than or equal to 65% by weight, identification of the tracer is further facilitated. On the other hand, when the addition amount of the non-fibrous inorganic particles exceeds 85% by weight, the fluidity of the resin composition for injection molding decreases, and injection molding becomes difficult. Therefore, the addition amount of the non-fibrous inorganic particles is preferably smaller than or equal to 80% by weight. In this case, it is possible to maintain good fluidity of the resin and to reduce defects such as defective filling of the end of the mold.

### [Coloring]

As described above, the resin composition for injection molding in the present embodiment includes the first thermoplastic resin and the non-fibrous inorganic particles as the filler, and may further include the aggregate and the resin composition as the tracer. From the viewpoint of identification of the tracer and aesthetic appearance of the molded article, each element constituting the resin composition for injection molding may be colored as follows.

The first thermoplastic resin, the aggregate, and the resin composition are preferably the same color, and particularly preferably black. As a result, the aggregates and the resin composition exposed on the surface of the ferrule 10 become less conspicuous, and the influence on the aesthetic appearance can be reduced. When the first thermoplastic resin, the aggregate, and the resin composition are black, it is possible to further reduce the influence on the aesthetic appearance. The aggregates and the resin composition as tracers can be confirmed by microscopic observation using a microscope or X-ray CT to identify the shape and orientation of the tracers. The brightness of the aggregate and the resin composition is preferably lower than that of the colored first thermoplastic resin. In this case, both the aesthetic appearance of the molded article surface and the visibility of the tracer can be achieved.

As described above, since the control of the aggregate of carbon black is relatively easy, the second inorganic particles constituting the aggregate are preferably carbon black. Further, by adding the same type of carbon black to the first thermoplastic resin and coloring the first thermoplastic resin in black, it is possible to further reduce deterioration in aesthetic appearance due to exposure of the aggregate. The brightness of the first thermoplastic resin can be appropriately adjusted according to the amount of carbon black added to the first thermoplastic resin. By making the brightness of the first thermoplastic resin higher than the brightness of the aggregate, that is, by making the blackness of the first thermoplastic resin lower than the blackness of the aggregate, observation of the aggregate using a microscope becomes easy.

Even in the case where the difference in brightness in visible light between the resin composition and the surrounding resin is not clearly expressed by a microscope, the difference between the components of the resin composition and the surrounding resin may be identified by an X-ray CT apparatus. Since the tracer resin composition includes a resin burn in which the second thermoplastic resin is oxidized at a high temperature, the oxygen content of the resin composition is higher than the oxygen content of the surrounding resin. The difference in oxygen content can appear on the X-ray image as a difference in X-ray absorptance. Therefore, even when it is difficult to optically identify the resin composition, the resin composition of the tracer can be identified by using the X-ray CT apparatus.

### [Manufacturing Method]

Next, a method for manufacturing a ferrule using the resin composition for injection molding will be described. FIG. 2 is a flowchart illustrating a method for manufacturing the ferrule 10 according to the present embodiment.

In step S101, first, an aggregate and a resin composition of a tracer are further added to the first thermoplastic resin and the non-fibrous inorganic particles. Here, the aggregate and the resin composition may be molded in advance to have a predetermined aspect ratio and a predetermined size. The first thermoplastic resin, the non-fibrous inorganic particles, the aggregate, and the resin composition are stirred by a Henschel mixer or the like, and further kneaded by a twin-screw kneading extruder or the like. Thus, the resin composition for injection molding including the tracer is produced. Instead of adding the resin composition, a resin composition in which a part of the first thermoplastic resin is blackened may be used as the tracer. That is, when the mixture including the first thermoplastic resin is extruded by the heated screw of the twin-screw kneading extruder, a resin burn (resin composition) in which a part of the first thermoplastic resin is blackened is generated. For example, when the screw temperature of the twin-screw kneading extruder is set to 330° C. or higher, the thermoplastic resin is baked on the screw surface. Further, the resin composition may have a desired aspect ratio and size by appropriately adjusting the screw rotation speed. When the resin composition is made black by heat process, the contour portion of the resin composition may be brown. However, brown contours are not particularly problematic in terms of aesthetics and tracer visibility of molded articles.

In step S102, the heated resin composition for injection molding is injected into a mold. After the resin composition for injection molding is cooled, the ferrule 10 is removed from the mold. Thereafter, as described later, the resin orientation can be estimated by observing the tracer in the ferrule 10.

### [Cross-Sectional Images]

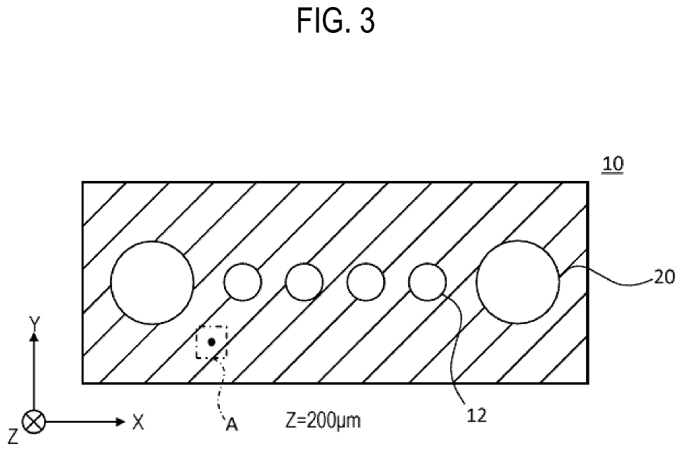

FIG. 3 is a cross-sectional view of the ferrule 10 according to the present embodiment. When the end surface 18 of the ferrule 10 is defined as an XY plane, a direction perpendicular to the XY plane is defined as a Z direction, and a position of the end surface 18 of the ferrule 10 is defined as Z=0. When the ferrule 10 is polished in the Z direction from the end surface, a cross section of the ferrule 10 appears. FIG. 3 illustrates a cross section of the ferrule 10 at Z=200 μm. A non-homogeneous portion, that is a tracer, different from the surrounding resin is exposed at the position indicated by the region A of the cross section.

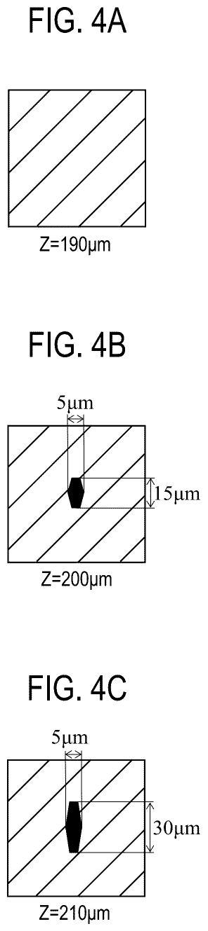

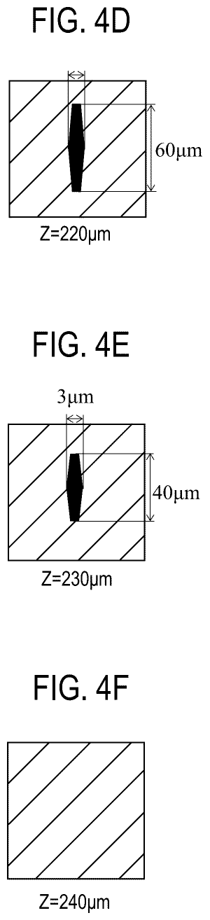

FIGS. 4A to 4F are enlarged cross-sectional views of a region A in the cross-sectional view of FIG. 3. FIGS. 4A to 4F illustrate enlarged cross-sectional views obtained by polishing the end surface of the ferrule 10 by each predetermined length (10 μm) in the Z direction. FIG. 4A illustrates a cross section of the ferrule 10 at Z=190 μm. In FIG. 4A, the tracer is not exposed in the cross-section. FIG. 4B illustrates a cross section of the ferrule 10 at Z=200 μm. In FIG. 4B, the tracer has a length of 5 μm in the X direction and a length of 15 μm in the Y direction. FIG. 4C illustrates a cross section of the ferrule 10 at Z=210 μm. In FIG. 4C, the tracer has a length of 5 μm in the X direction and a length of 30 μm in the Y direction. FIG. 4D illustrates a cross section of the ferrule 10 at Z=220 μm. In FIG. 4D, the tracer has a length of 4 μm in the X direction and a length of 60 μm in the Y direction. FIG. 4E illustrates a cross section of the ferrule 10 at Z=230 μm. In FIG. 4E, the tracer has a length of 3 μm in the X direction and a length of 40 μm in the Y direction. FIG. 4F illustrates a cross section of the ferrule 10 at Y=240 μm. In FIG. 4F, the tracer is not exposed in the cross-section.

Since tracers were observed at Z=200 μm, 210 μm, 220 μm and 230 μm, the length of the tracer in the Z direction was about 30 μm. The tracer has a length of 5 μm in the X direction and a length of 60 μm in the Y direction. Thus, the aspect ratio of the tracer was observed to be 60/5=12. This aspect ratio meets the above-described conditions of the present embodiment. By using the tracer in the present embodiment, the orientation of the resin can be estimated without increasing the anisotropy of the surrounding resin.

### [Analyzing Apparatus and Analyzing Method]

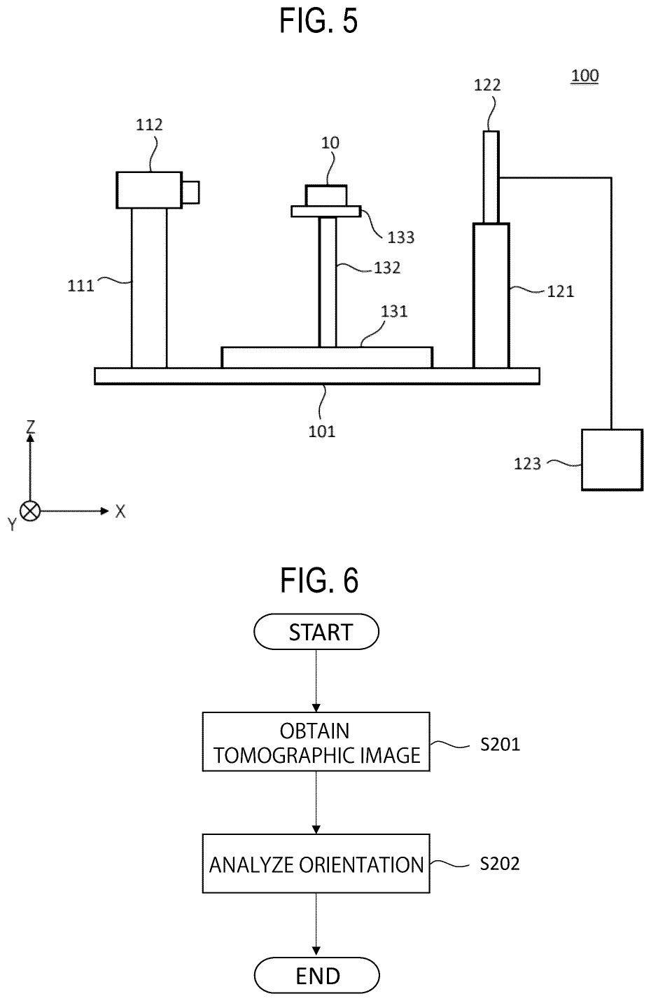

FIG. 5 is a schematic diagram of an analyzing apparatus of resin orientation according to the present embodiment. The analyzing apparatus 100 includes a table 101, a supporting part 111, an X-ray irradiation part 112, a supporting part 121, an X-ray detection part 122, an image processing part 123, a first driving part 131, a second driving part 132, and a holder 133.

The table 101 has an elongated plate shape, is placed on a ground plane (XY plane), and is made of a hard material such as metal or glass. A columnar supporting part 111 is provided on a left upper surface of the table 101. The supporting part 111 has a columnar shape, and the X-ray irradiation part 112 is provided on an upper portion of the supporting part 111.

A columnar supporting part 121 is provided on a right upper surface of the table 101, and the X-ray detection part 122 is provided on an upper portion of the supporting part 121. The X-ray detection part 122 converts the X-ray transmitted through the ferrule 10 into an electrical signal, and outputs a tomographic image to the image processing part 123. The image processing part 123 includes a processor, a memory, display, and the like, and can analyze the orientation of the resin of the ferrule 10 based on the tomographic image from the X-ray detection part 122.

The first driving part 131 including a motor, a rail, and the like is provided on a central upper surface of the table 101. The second driving part 132 is provided on an upper surface of the first driving part 131, and the first driving part 131 can move the second driving part 132 in the front-rear direction (X direction). The second driving part 132 includes a motor, a rotation shaft capable of moving up and down, and the like, and the holder 133 is provided above the second driving part 132. The second driving part 132 can move and rotate the holder 133 up and down by raising and lowering and rotating the rotation shaft. The holder 108 has a flat plate shape, and the ferrule 10 is held by the holder 133.

By moving and rotating the holder 133 while holding the ferrule 10, the X-ray irradiation part 112 can irradiate the ferrule 10 with X-rays at various positions and in various directions. Accordingly, the X-ray detection part 122 can obtain a tomographic image in an arbitrary cross section of the ferrule 10, and the image processing part 123 can analyze the resin orientation based on the image of the tracer included in the tomographic image.

An analyzing method of a resin orientation according to the present embodiment will be described with reference to FIG. 6. FIG. 6 is a flowchart illustrating analyzing method of a flow direction of a resin according to the present embodiment.

First, a tomographic image of the ferrule 10 is obtained (step S201). The tomographic image of the ferrule 10 can be obtained by, for example, a method using an X-ray CT apparatus or a method of microscopically observing a cross section obtained by polishing the ferrule 10.

Next, the orientation of the resin of the ferrule 10 is analyzed based on the tracer appearing in the tomographic image of the ferrule 10 (step S202). The flow direction of the resin may be determined by tomographic images obtained from a single ferrule 10, or may be determined by tomographic images obtained from a plurality of ferrules 10. The analysis of the orientation may be performed by visual observation of a microscope or may be automatically performed by an image processing apparatus. The analysis result is recorded in the image processing part 123 of the analyzing apparatus 100, and can be used for quality control or the like in the plurality of ferrules 10.

### [Effect]

As described above, according to the present embodiment, the orientation of the resin can be estimated while suppressing anisotropy by using at least one of the aggregate and the resin composition as the tracer. Hereinafter, the effect of the present embodiment will be described in detail in comparison with the related art.

In a high-precision injection molded article, for example, an MT ferrule, which requires dimensional accuracy on the order of submicrons, it is desirable that thermal dimensional changes due to molding shrinkage and linear expansion coefficient are isotropic. However, thermoplastic resins, particularly crystalline resins, exhibit different dimensional changes during molding in the flow direction (MD) and in the direction perpendicular thereto (TD), and have so-called anisotropy.

In addition, fibrous or needle inorganic particles are added as a filler or a reinforcing material. The linear expansion coefficient of the fibrous or needle-like inorganic particles is small. However, since the surrounding resin is restricted by the inorganic particles, the orientation of the resin composition around the inorganic particles is different in each of the longitudinal direction and the perpendicular direction, and the anisotropy of the dimensional change of the resin is increased. That is, the fibrous or needle-like inorganic particles cannot expand and contract in the longitudinal direction, and dimensional changes are concentrated in the vertical direction. Therefore, the filler preferably has a shape with little anisotropy such as a spherical shape, a polygonal shape, an irregular shape, or a crushed shape.

As described above, the anisotropy caused by the filler or the reinforcing material can be reduced by selecting the shape of the inorganic particle, but the anisotropy of the thermoplastic resin itself is allowed to be used.

When molded articles such as ferrules are mass-produced, the dimensions of the molded articles vary depending on the production lots even though the molded articles are produced using the same mold and under the same conditions, and defective articles may occur. In this case, in the manufacturing process, it is necessary to investigate the cause of the defective article from among a number of manufacturing conditions such as a material, a mold, and a molding machine, and take measures. Such causal surveys and measures require a lot of time and effort, which can result in reduced productivity. In addition, since the cause survey largely relies on the experienced intuition of the person in charge, the load tends to concentrate on a specific skilled person in charge. Therefore, it has been desired to establish an analyzing method based on objective information.

As a result of intensive studies, the inventors of the present invention have found that there are many cases in which a variation in mold or a variation in resin flow is caused. Specifically, the variation of the mold may be a slight displacement of the mold parts during manufacturing or a slight change in the mold shape due to wear of the mold by the resin. The dimension of the molded article transferred by such a mold also changes. The variation in the resin flow is caused by a change in the resin flow due to a difference in the resin viscosity depending on the material lot. That is, as described above, when the orientation of the polymer having anisotropy in the dimensional change is changed, the direction in which the molding shrinkage is large is changed, and the dimension of the molded article is changed in some cases. Therefore, if the orientation of the resin can be objectively evaluated, it can be identified as one of the two causes described above, and the time and labor required for the cause investigation can be greatly reduced.

As a technique for estimating the orientation, it can be considered to use it as a tracer added to the filler. The technique described in Japanese Patent Application Laid-Open No. 2014-100879 uses fibrous inorganic particles as tracers and estimates the orientation of the resin from the fiber direction. However, since the fibrous inorganic particles cannot be deformed in accordance with the expansion and contraction of the surrounding resin, the deformation of the resin is restricted, and the anisotropy of the injection molded article is increased. Japanese Patent Application Laid-Open No. 1993-345328 describes a filler having small anisotropy. However, since the filler described in this document has high symmetry, it is difficult to obtain information on resin orientation from the filler. Furthermore, Japanese Patent Application Laid-Open No. 2004-29415 describes a small amount of a needle filler. However, even if the amount of the needle filler is small, sufficient dimensional accuracy cannot be obtained in a product requiring dimensional accuracy of a submicron level.

Although there is also a method of directly analyzing the molecular orientation without using a tracer, the apparatus is generally expensive, and a sophisticated specialized technique is required for sample preparation, operation, analysis, and the like. In addition, since measurement or analysis takes time, it is not practical to employ such an analyzing method at the manufacturing site.

Due to the above background, it has been desired to estimate the resin orientation in the molded article in a short time by a simple method at the manufacturing site without impairing the isotropy of the molded article. Through intensive studies, the inventors have found that the orientation of the resin can be estimated without impairing the isotropy of the resin by the following characteristic configuration.

First, the tracer preferably has anisotropy. For example, the tracer in the present embodiment has a predetermined aspect ratio such as a flat shape, a rod shape, or a needle shape. The flow direction of the resin can be estimated by observing the longitudinal direction of the tracer with a microscope, an X-ray CT apparatus, or the like.

Second, the tracer preferably has flexibility. As described above, the tracer in the present embodiment is composed of an aggregate of inorganic particles or a resin composition having a small diameter. As a result, the tracer deforms according to the expansion and contraction of the resin, and the influence on the dimensional accuracy and anisotropy of the resin is minimized. The aggregate of inorganic particles has higher flexibility than a single inorganic particle.

Third, the filler preferably has isotropy or symmetry in shape. In the present embodiment, non-fibrous inorganic particles having isotropy are added as a filler. This makes it possible to suppress an increase in anisotropy of the resin due to the filler.

Fourth, the filler is preferably distinguishable from the tracer. In the present embodiment, the filler is composed of non-fibrous inorganic particles and has small anisotropy. Therefore, it is possible to distinguish between the tracer having anisotropy and the filler.

According to the characteristic configuration described above, it was confirmed by the following Examples that the orientation of the resin can be estimated while suppressing anisotropy.

### EXAMPLE

Next, Examples and Comparative Examples of the present invention will be described. A resin composition for injection molding used for the MT ferrule was manufactured while changing the manufacturing conditions.

TABLE 1

| | First | | | | | | | | |
|---|---|---|---|---|---|---|---|---|---|
| | thermo- | Non-fibrous | | | | | | | |
| | plastic | inorganic | Non-fibrous | | | Resin | | | |
| | resin | particle | inorganic | Pigment | Aggregate | composition | | | |
| | (weight | (weight | particle | (weight | (weight | (weight | | | |
| | parts) | parts) | (wt %) | parts) | parts) | parts) | Evaluation 1 | Evaluation 2 | Evaluation 3 |
| Example 1 | 100 | 300 | 74.6 | 2 | 0.1 | — | OK | OK | OK |
| Example 2 | 100 | 300 | 74.6 | 2 | — | 0.1 | OK | OK | OK |
| Example 3 | 100 | 300 | 74.6 | 2 | 0.1 | — | OK | OK | OK |
| Example 4 | 100 | 300 | 74.9 | 0.5 | 0.1 | — | OK | OK | OK |
| Example 5 | 100 | 200 | 66.2 | 2 | 0.1 | — | OK | OK | OK |
| Example 6 | 100 | 300 | 74.6 | 2 | 0.05 | — | OK | OK | OK |
| Example 7 | 100 | 300 | 74.4 | 2 | 1 | — | OK | OK | OK |
| Example 8 | 100 | 300 | 74.6 | 2 | 0.1 | — | OK | OK | OK |
| Example 9 | 100 | 300 | 74.6 | 2 | 0.1 | — | OK | OK | OK |
| Comparative | 100 | 300 | 75.0 | — | — | — | NG | NG | OK |
| Example 1 | | | | | | | | | |
| Comparative | 100 | 300 | 75.0 | — | — | 0.1 | NG | NG | OK |
| Example 2 | | | | | | | | | |

Table 1 illustrates the first thermoplastic resin (weight parts), the non-fibrous inorganic particles (weight parts), the non-fibrous inorganic particles (wt %), the aggregate (weight parts), the resin composition (weight parts), Evaluations 1 and 2 of the heterogeneous portion (tracer), and Evaluation 3 of the anisotropy caused by the tracer. “Evaluation 1” indicates whether or not a tracer satisfying the standard (aspect ratio of larger than or equal to 2 and smaller than or equal to 20 and major axis length of larger than or equal to 25 μm and smaller than or equal to 100 μm) can be confirmed by the microscope observation. When a tracer satisfying the standard can be confirmed, Evaluation 1 is judged to be good (OK), and when it cannot be confirmed, Evaluation 1 is judged to be poor (NG). “Evaluation 2” indicates whether or not a tracer satisfying the standard (aspect ratio of larger than or equal to 2 and smaller than or equal to 20 and major axis length of larger than or equal to 25 μm and smaller than or equal to 100 μm) can be confirmed by X-ray CT observation. When a tracer satisfying the standard can be confirmed, Evaluation 1 is judged to be good (OK), and when it cannot be confirmed, Evaluation 1 is judged to be poor (NG). “Evaluation 3” indicates whether or not the influence of anisotropy and dimensional change caused by the tracer can be confirmed. When the influence of the anisotropy and the dimensional change due to the tracer cannot be confirmed, the Evaluation 3 is judged to be good (OK), and when the influence can be confirmed, the Evaluation 3 is judged to be poor (NG).

### Example 1

In Example 1, the following materials were prepared as components of the resin composition for injection molding. As the first thermoplastic resin, 100 weight parts of a crosslinked polyphenylene sulfide resin (manufactured by DIC Corporation: melt viscosity 27 Pa·s (corresponding to JIS K-7210, measurement temperature 300° C., load 20 kgf, die 1.0 mm×10 mm)) were prepared. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 74.6% by weight of non-fibrous inorganic particles was added. As a pigment for coloring, 2 weight parts of Toka Black #7360SB (trade name, manufactured by Tokai Carbon), which is carbon black for coloring, were added. As an aggregate of the second inorganic particles for the tracer, 0.1 weight part of Tokablack #7360SB (trade name, manufactured by Tokai Carbon) as carbon black was added. The second thermoplastic resin and resin composition for the tracer were not added.

The above materials were mixed and kneaded at 350° C. and a screw rotation speed of 400 rpm in a twin-screw extruder to produce pellets. The pellets were hot pressed and then polished to expose the flat resin composition on the pellet surfaces. The exposed resin composition had a lower brightness than the portion of the first thermoplastic resin, and thus could be identified by a microscope. Furthermore, the resin composition had a peak in common with the first thermoplastic resin by qualitative analysis by FT-IR. Therefore, it was confirmed that the main component of the resin composition was the first thermoplastic resin.

Subsequently, an MT ferrule was molded using the resin product for injection molding of Example 1. First, when tomographic observation of the MT ferrule was performed by a microscope and X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 2

In Example 2, 100 weight parts of a crosslinked polyphenylene sulfide resin (manufactured by DIC Corporation: melt viscosity 27 Pa·s (corresponding to JIS K-7210, measurement temperature 300° C., load 20 kgf, die 1.0 mm×10 mm)) were prepared as the first thermoplastic resin. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 74.6% by weight of non-fibrous inorganic particles was added. As a pigment for coloring, 2 weight parts of Toka Black #7360SB (trade name, manufactured by Tokai Carbon), which is carbon black for coloring, were added. Aggregates of the second inorganic particles for the tracer were not added. As the second thermoplastic resin for the tracer, a PPS resin of the same type as the first thermoplastic resin was heated in oxygen at 320° C. for 1 hour to be blackened. The blackened PPS resin was ground and then sieved to obtain a resin composition having a major axis length of smaller than or equal to 100 μm. In the kneading step, 0.1 weight part of the resin composition was added.

The above materials excluding the resin composition were mixed, and kneaded by a twin-screw extruder at 300° C. at a screw rotation speed of 400 rpm to produce pellets. The pellets were hot pressed and then polished, and the flat resin composition was not exposed on the pellet surface. Therefore, in Example 2, it was confirmed that the resin composition was not produced during the kneading step.

Subsequently, an MT ferrule was molded using the resin product for injection molding of Example 2. First, when the MT ferrule was subjected to tomographic observation by X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 3

In Example 3, 100 weight parts of a crosslinked polyphenylene sulfide resin (manufactured by DIC Corporation: melt viscosity 27 Pa·s (corresponding to JIS K-7210, measurement temperature 300° C., load 20 kgf, die 1.0 mm×10 mm)) were prepared as the first thermoplastic resin. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 74.6% by weight of non-fibrous inorganic particles was added. As a pigment for coloring, 2 weight parts of Toka Black #7360SB (trade name, manufactured by Tokai Carbon), which is carbon black for coloring, were added. As an aggregate of the second inorganic particles for the tracer, 0.1 weight part of Tokablack #7360SB (trade name, manufactured by Tokai Carbon) as carbon black was added. The second thermoplastic resin and resin composition for the tracer were not added.

The above materials were mixed and kneaded at 300° C. and a screw rotation speed of 400 rpm in a twin-screw extruder to produce pellets. The pellets were hot pressed and then polished, and the flat resin composition was not exposed on the pellet surface. Therefore, in Example 3, it was confirmed that the resin composition was not produced during the kneading step.

Subsequently, an MT ferrule was molded using the resin product for injection molding of Example 3. First, when the MT ferrule was subjected to tomographic observation by X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 4

In Example 4, 100 weight parts of a crosslinked polyphenylene sulfide resin (manufactured by DIC Corporation: melt viscosity 27 Pa's (corresponding to JIS K-7210, measurement temperature 300° C., load 20 kgf, die 1.0 mm×10 mm)) were prepared as the first thermoplastic resin. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 74.9% by weight of non-fibrous inorganic particles was added. As a pigment for coloring, 0.5 weight part of Toka Black #7360SB (trade name, manufactured by Tokai Carbon), which is carbon black for coloring, was added. As an aggregate of the second inorganic particles for the tracer, 0.1 weight part of silica particles (particle diameter of smaller than or equal to 1 μm, manufactured by Admatechs) was added. In order to suppress the silica particles from being dispersed in the first thermoplastic resin, a surface treatment agent or the like was not used for the silica particles. The second thermoplastic resin and resin composition for the tracer were not added.

The above materials were mixed and kneaded at 350° C. and a screw rotation speed of 400 rpm in a twin-screw extruder to produce pellets. The pellets were hot pressed and then polished to expose the flat resin composition on the pellet surfaces. The exposed resin composition had a lower brightness than the portion of the first thermoplastic resin, and thus could be identified by a microscope. Furthermore, the resin composition had a peak in common with the first thermoplastic resin by qualitative analysis by FT-IR. Therefore, it was confirmed that the main component of the resin composition was the first thermoplastic resin.

Subsequently, an MT ferrule was molded using the resin product for injection molding of Example 4. First, when the MT ferrule was subjected to tomographic observation by X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 5

In Example 5, the following materials were prepared as components of the resin composition for injection molding. As the first thermoplastic resin, 100 weight parts of a crosslinked polyphenylene sulfide resin (manufactured by DIC Corporation: melt viscosity 27 Pa·s (corresponding to JIS K-7210, measurement temperature 300° C., load 20 kgf, die 1.0 mm×10 mm)) were prepared. As the non-fibrous inorganic particles as the filler, 200 weight parts of a high purity spherical silica filler (particle diameter of smaller than or equal to 25 μm, manufactured by Admatechs) were added. As a material of the resin composition for injection molding, 66.2% by weight of non-fibrous inorganic particles was added. As a pigment for coloring, 2 weight parts of Toka Black #7360SB (trade name, manufactured by Tokai Carbon), which is carbon black for coloring, were added. As an aggregate of the second inorganic particles for the tracer, 0.1 weight w part of Tokablack #7360SB (trade name, manufactured by Tokai Carbon) as carbon black was added. The second thermoplastic resin and resin composition for the tracer were not added.

The above materials were mixed and kneaded at 350° C. and a screw rotation speed of 400 rpm in a twin-screw extruder to produce pellets. The pellets were hot pressed and then polished to expose the flat resin composition on the pellet surfaces. The exposed resin composition had a lower brightness than the portion of the first thermoplastic resin, and thus could be identified by a microscope. Furthermore, the resin composition had a peak in common with the first thermoplastic resin by qualitative analysis by FT-IR. Therefore, it was confirmed that the main component of the resin composition was the first thermoplastic resin.

Subsequently, an MT ferrule was molded using the resin product for injection molding of Example 5. First, when tomographic observation of the MT ferrule was performed by a microscope and X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 6

In Example 6, the following materials were prepared as components of the resin composition for injection molding. As the first thermoplastic resin, 100 weight parts of a crosslinked polyphenylene sulfide resin (manufactured by DIC Corporation: melt viscosity 27 Pa·s (corresponding to JIS K-7210, measurement temperature 300° C., load 20 kgf, die 1.0 mm×10 mm)) were prepared. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 74.6% by weight of non-fibrous inorganic particles was added. As a pigment for coloring, 2 weight parts of Toka Black #7360SB (trade name, manufactured by Tokai Carbon), which is carbon black for coloring, were added. As an aggregate of the second inorganic particles for the tracer, 0.05 weight part of Tokablack #7360SB (trade name, manufactured by Tokai Carbon) as carbon black was added. The second thermoplastic resin and resin composition for the tracer were not added.

The above materials were mixed and kneaded at 350° C. and a screw rotation speed of 400 rpm in a twin-screw extruder to produce pellets. The pellets were hot pressed and then polished to expose the flat resin composition on the pellet surfaces. The exposed resin composition had a lower brightness than the portion of the first thermoplastic resin, and thus could be identified by a microscope. Furthermore, the resin composition had a peak in common with the first thermoplastic resin by qualitative analysis by FT-IR. Therefore, it was confirmed that the main component of the resin composition was the first thermoplastic resin.

Subsequently, an MT ferrule was molded using the resin product for injection molding of Example 6. First, when tomographic observation of the MT ferrule was performed by a microscope and X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 7

In Example 7, the following materials were prepared as components of the resin composition for injection molding. As the first thermoplastic resin, 100 weight parts of a crosslinked polyphenylene sulfide resin (manufactured by DIC Corporation: melt viscosity 27 Pa's (corresponding to JIS K-7210, measurement temperature 300° C., load 20 kgf, die 1.0 mm×10 mm)) were prepared. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 74.4% by weight of non-fibrous inorganic particles was added. As a pigment for coloring, 2 weight parts of Toka Black #7360SB (trade name, manufactured by Tokai Carbon), which is carbon black for coloring, were added. As an aggregate of the second inorganic particles for the tracer, 1 weight part of Tokablack #7360SB (trade name, manufactured by Tokai Carbon) as carbon black was added. The second thermoplastic resin and resin composition for the tracer were not added.

The above materials were mixed and kneaded at 350° C. and a screw rotation speed of 400 rpm in a twin-screw extruder to produce pellets. The pellets were hot pressed and then polished to expose the flat resin composition on the pellet surfaces. The exposed resin n composition had a lower brightness than the portion of the first thermoplastic resin, and thus could be identified by a microscope. Furthermore, the resin composition had a peak in common with the first thermoplastic resin by qualitative analysis by FT-IR. Therefore, it was confirmed that the main component of the resin composition was the first thermoplastic resin.

Subsequently, an MT ferrule was molded using the resin product for injection molding of Example 7. First, when tomographic observation of the MT ferrule was performed by a microscope and X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 8

In Example 8, the following materials were prepared as components of the resin composition for injection molding. As the first thermoplastic resin, 100 weight parts of crosslinked polyphenylene sulfide resin (DIC Corporation: melt viscosity 27 Pa·s (corresponding to JIS K-7210, measurement temperature 300° C., load 20 kgf, die 1.0 mm×10 mm)) were prepared. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 74.6% by weight of non-fibrous inorganic particles was added. As a pigment for coloring, 2 weight parts of Asahi carbon SB320 as carbon black for coloring were added. As an aggregate of the second inorganic particles for the tracer, 0.1 weight part of Asahi carbon SB320 as carbon black was added. The second thermoplastic resin and resin composition for the tracer were not added.

The above materials were mixed and kneaded at 350° C. and a screw rotation speed of 400 rpm in a twin-screw extruder to produce pellets. The pellets were hot pressed and then polished to expose the flat resin composition on the pellet surfaces. The exposed resin composition had a lower brightness than the portion of the first thermoplastic resin, and thus could be identified by a microscope. Furthermore, the resin composition had a peak in common with the first thermoplastic resin by qualitative analysis by FT-IR. Therefore, it was confirmed that the main component of the resin composition was the first thermoplastic resin.

Subsequently, an MT ferrule was molded using the resin product for injection molding of Example 8. First, when tomographic observation of the MT ferrule was performed by a microscope and X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Example 9

In Example 9, the following materials were prepared as components of the resin composition for injection molding. As the first thermoplastic resin, 100 weight parts of crosslinked polyphenylene sulfide resin (DIC Corporation: melt viscosity 27 Pa·s (corresponding to JIS K-7210, measurement temperature 300° C., load 20 kgf, die 1.0 mm×10 mm)) were prepared. As the non-fibrous inorganic particles as the filler, 300 weight parts of a mixture of a high purity spherical silica filler (particle diameter: smaller than or equal to 25 μm, manufactured by Admatechs) and an amorphous silica filler (particle diameter: smaller than or equal to 25 μm, manufactured by TATSUMORI) were added. As a material of the resin composition for injection molding, 74.6% by weight of non-fibrous inorganic particles was added. As a pigment for coloring, 2 weight parts of Asahi carbon SB320 as carbon black for coloring were added. As an aggregate of the second inorganic particles for the tracer, 0.1 weight part of Asahi carbon SB320 as carbon black was added. The second thermoplastic resin and resin composition for the tracer were not added.

The above materials were mixed and kneaded at 350° C. and a screw rotation speed of 400 rpm in a twin-screw extruder to produce pellets. The pellets were hot pressed and then polished to expose the flat resin composition on the pellet surfaces. The exposed resin composition had a lower brightness than the portion of the first thermoplastic resin, and thus could be identified by a microscope. Furthermore, the resin composition had a peak in common with the first thermoplastic resin by qualitative analysis by FT-IR. Therefore, it was confirmed that the main component of the resin composition was the first thermoplastic resin.

Subsequently, an MT ferrule was molded using the resin product for injection molding of Example 9. First, when tomographic observation of the MT ferrule was performed by a microscope and X-ray CT, tracers having an aspect ratio of larger than or equal to 2 and smaller than or equal to 20 and a major axis length of larger than or equal to 25 μm and smaller than or equal to 100 μm were confirmed (Evaluation 1: OK, Evaluation 2: OK). In addition, the influence of anisotropy and dimensional change due to the tracer was not confirmed (Evaluation 3: OK).

### Comparative Example 1

In Comparative Example 1, 100 weight parts of crosslinked polyphenylene sulfide resin (DIC Corporation: melt viscosity 27 Pa·s (corresponding to JIS K-7210, measurement temperature 300° C., load 20 kgf, die 1.0 mm×10 mm)) were prepared as the first thermoplastic resin. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 75.0% by weight of non-fibrous inorganic particles was added. Pigment for coloring was not added. Aggregates of the second inorganic particles as tracers were not added. The second thermoplastic resin and resin composition for the tracer were not added.

The above materials were mixed and kneaded at 300° C. and a screw rotation speed of 400 rpm in a twin-screw extruder to produce pellets. The pellets were hot pressed and then polished, and the flat resin composition was not exposed on the pellet surface. Therefore, in Comparative Example 1, it was confirmed that the resin composition was not produced during the kneading step.

Subsequently, an MT ferrule was molded using the resin product for injection molding of Comparative Example 1. First, when the MT ferrule was subjected to tomographic observation by X-ray CT, tracers having an aspect ratio of larger than or equal to 2 and smaller than or equal to 20 and a major axis length of larger than or equal to 25 μm and smaller than or equal to 100 μm could not be confirmed (Evaluation 1: NG, Evaluation 2: NG). In addition, the influence of anisotropy and dimensional change due to the tracer was not confirmed (Evaluation 3: OK).

### Comparative Example 2

In Comparative Example 2, 100 weight parts of crosslinked polyphenylene sulfide resin (DIC Corporation: melt viscosity 27 Pa's (corresponding to JIS K-7210, measurement temperature 300° C., load 20 kgf, die 1.0 mm×10 mm)) were prepared as the first thermoplastic resin. As the non-fibrous inorganic particles as the filler, 300 weight parts of a high purity spherical silica filler (particle diameter of smaller than or equal to 25 μm, manufactured by Admatechs) were added. As a material of the resin composition for injection molding, 75.0% by weight of non-fibrous inorganic particles was added. Pigment was not added for coloring. Aggregates of the second inorganic particles as tracers were not added. As the second thermoplastic resin for the tracer, a PPS resin of the same type as the first thermoplastic resin was heated in oxygen at 320° C. for 1 hour to be blackened. The blackened PPS resin was ground and then sieved to obtain a resin composition having a major axis length of smaller than or equal to 25 μm. In the kneading step, 0.1 weight part of the resin composition was added.

The above materials excluding the resin composition were mixed, and kneaded by a twin-screw extruder at 300° C. at a screw rotation speed of 400 rpm to produce pellets. The pellets were hot pressed and then polished, and the flat resin composition was not exposed on the pellet surface. Therefore, in Comparative Example 2, it was confirmed that the resin composition was not produced during the kneading step.

Subsequently, an MT ferrule was molded using the resin product for injection molding of Comparative Example 2. First, when the MT ferrule was subjected to tomographic observation by X-ray CT, tracers having an aspect ratio of larger than or equal to 2 and smaller than or equal to 20 and a major axis length of larger than or equal to 25 μm and smaller than or equal to 100 μm could not be confirmed (Evaluation 1: NG, Evaluation 2: NG). In addition, the influence of anisotropy and dimensional change due to the tracer was not confirmed (Evaluation 3: OK).

As described above, according to the present embodiment, the orientation of the resin can be estimated while suppressing anisotropy by using the aggregate and the resin composition as tracers.

The present invention is not limited to the above-described embodiment, and various modifications are possible. In addition, well-known techniques and publicly known techniques in the technical field can be appropriately applied to portions which are not particularly described or illustrated in the embodiments. The resin molded article produced by the above-described resin composition for injection molding is not limited to component for an optical electronic device such as a ferrule, and can be applied to various components and products.

What is claimed is:

1. A resin composition for injection molding comprising a first thermoplastic resin and a filler including a non-fibrous first inorganic particle,
further comprising at least one of an aggregate of second inorganic particles and a resin composition of a second thermoplastic resin,
wherein a ratio of a longest first length to a shortest second length among lengths of the aggregate and the resin composition in three directions orthogonal to each other is larger than or equal to 2 and smaller than or equal to 20, and the first length is larger than or equal to 25 μm and smaller than or equal to 100 μm, and
wherein the aggregate or the resin composition does not include the first inorganic particles having a particle diameter of larger than or equal to 25 μm.

2. The resin composition for injection molding according to claim 1, wherein a cumulative 99% particle diameter D₉₉ of the first inorganic particles is smaller than or equal to 25 μm.

3. The resin composition for injection molding according to claim 1, wherein a particle diameter of the second inorganic particles is smaller than or equal to 1 μm.

4. The resin composition for injection molding according to claim 1, wherein the first thermoplastic resin and the second thermoplastic resin are a same type of resin.

5. The resin composition for injection molding according to claim 1, wherein a softening temperature of the resin composition is higher than a softening temperature of the first thermoplastic resin.

6. The resin composition for injection molding according to claim 1, wherein an addition amount of the first inorganic particles is larger than or equal to 50% by weight and smaller than or equal to 85% by weight.

7. The resin composition for injection molding according to claim 1, wherein the first thermoplastic resin, the aggregate, and the resin composition are black.

8. The resin composition for injection molding according to claim 1, wherein the first thermoplastic resin is polyarylene sulfide.

9. The resin composition for injection molding according to claim 1, wherein the first inorganic particles are spherical or polygonal silica particles.

10. The resin composition for injection molding according to claim 1, wherein the second inorganic particles are carbon black.

11. The resin composition for injection molding according to claim 1, wherein the aggregate and the resin composition are used as a tracer for determining anisotropy of the injection molded article.

12. An injection molded article comprising the resin composition for injection molding according to claim 1.

13. A component for an optical electronic device comprising the resin composition for injection molding according to claim 1.

14. A ferrule for optical fiber connection comprising the resin composition for injection molding according to claim 1.

15. A method for manufacturing an injection molded article comprising:
a first step of kneading a first thermoplastic resin, a non-fibrous first inorganic particle, and at least one of an aggregate of second inorganic particles and a resin composition of a second thermoplastic resin; and
a second step of injection-molding a mixture of the first step,
wherein a ratio of a longest first length to a shortest second length among lengths of the aggregate and the resin composition in three directions orthogonal to each other is larger than or equal to 2 and smaller than or equal to 20, and the first length is larger than or equal to 25 μm and smaller than or equal to 100 μm, and
wherein the aggregate or the resin composition does not include the first inorganic particles having a particle diameter of larger than or equal to 25 μm.

16. The method for manufacturing the injection molded article according to claim 15, wherein a cumulative 99% particle diameter D₉₉ of the first inorganic particles is smaller than or equal to 25 μm.

17. The method for manufacturing the injection molded article according to claim 15, wherein a particle diameter of the second inorganic particles is smaller than or equal to 1 μm.

18. The method for manufacturing the injection molded article according to claim 15, wherein in the first step, a part of the first thermoplastic resin is blackened to form the resin composition.

19. The method for manufacturing the injection molded article according to claim 15, wherein the first thermoplastic resin and the second thermoplastic resin are a same type of resin.

20. A method for analyzing an injection molded article comprising:
acquiring a tomographic image of an injection molded article including a first thermoplastic resin, a non-fibrous first inorganic particle, and at least one of an aggregate of second inorganic particles and a resin composition of a second thermoplastic resin; and
determining an orientation of the aggregate or the resin composition in the tomographic image,
wherein a ratio of a longest first length to a shortest second length among lengths of the aggregate and the resin composition in three directions orthogonal to each other is larger than or equal to 2 and smaller than or equal to 20, and the first length is larger than or equal to 25 μm and smaller than or equal to 100 μm, and
wherein the aggregate or the resin composition does not include the first inorganic particles having a particle diameter of larger than or equal to 25 μm.

21. The method for analyzing the injection molded article according to claim 20, wherein a cumulative 99% particle diameter D₉₉ of the first inorganic particles is smaller than or equal to 25 μm.

22. The method for analyzing the injection molded article according to claim 20, wherein a particle diameter of the second inorganic particles is smaller than or equal to 1 μm.
